(19) United States
(12) Patent Application Publication
(10) Pub. No.: US 2010/0277803 A1
(43) Pub. Date: Nov. 4, 2010

(54) Display Device Having Two Operating Modes

(75) Inventors: Lachlan Pockett, Tampere (FI); Tapani Levola, Tampere (FI); Jukka Parviainen, Tampere (FI); Marja Salmimaa, Tampere (FI); Jarkko Viinikanoja, Tampere (FI); Markus Virta, Tampere (FI)

Correspondence Address: Nokia, Inc., 6021 Connection Drive, MS 2-5-520, Irving, TX, 75039, US

(73) Assignee: NOKIA CORPORATION, Espoo (FI)

(21) Appl. No.: 12/519,165

(22) PCT Filed: Dec. 14, 2006
(86) PCT No.: PCT/FI2006/050556

§ 371 Date: May 27, 2010

(51) Int. Cl. G02B 27/02; G02B 27/44; G02B 27/22; G03B 21/00

(52) U.S. Cl. 359/567; 359/466; 353/122; 353/121

(57) ABSTRACT

A display device (500) comprises a micro-display (22) and imaging optics (24) to transmit a light beam (BO), and a diffractive beam expander (10) having an output grating (16). The combination of said micro-display (22) and said imaging optics (24) is together adapted to form a virtual image (710) which is observable through the perimeter (15) of said output grating (16) when said diffractive beam expander (10) is positioned to at least partially intercept said light beam (BO). The combination of said micro-display (22) and said imaging optics (24) may also be adapted to project said light beam (BO) onto an external screen (600) in order to display a real image (610). The display device (500) may comprise a movable optical component (10, 380) to switch the device (500) from a virtual display mode to a projecting mode.

### FIELD OF THE INVENTION

The present invention relates to displaying virtual images by using a micro-display, imaging optics, and a diffractive beam expander.

### BACKGROUND OF THE INVENTION

Display modules are used in portable devices to display information in graphical form. Small size is an important aspect in portable devices. However, the small size of a portable device also sets a limitation to the size of a display module incorporated in said device. A typical drawback of a conventional small display is that an observer can examine only a small portion of a large displayed image at a glance, while preserving adequate resolution.

An approach to display a large image by using a small display module is to use a near-eye display. A near-eye display based on a diffractive beam expander is disclosed e.g. in a patent application EP0535402

### SUMMARY OF THE INVENTION

The object of the present invention is to provide a display device.

According to a first aspect of the invention, there is provided a display device according to claim 1.

According to a second aspect of the invention, there is provided a method for displaying images according to claim 15.

According to a third aspect of the invention, there is provided a display means according to claim 18.

According to a fourth aspect of the invention, there is provided a connectable diffractive beam expander according to claim 20.

According to a fifth aspect of the invention, there is provided a connectable optical component according to claim 23.

According to a sixth aspect of the invention, there is provided a connectable micro display according to claim 24.

The display device may be adapted to display a virtual image through a viewing aperture and to project a real image on an external screen. Said virtual image and said real image may be displayed simultaneously or in different operating modes.

In an embodiment, said device has at least two operating modes: a first operating mode for displaying a virtual image and a second mode for projecting a real image on an external screen.

The display device comprises a micro-display, imaging optics having an output aperture to transmit a light beam, and a diffractive beam expander having a viewing aperture. An movable optical component of said device may have a first position with respect to said output aperture to set said diffractive beam expander into the path of said light beam in order to enable a first mode of operation, and a second position with respect to said output aperture to remove said diffractive beam expander from the path of said first light beam to enable a second mode of operation. The combination of said micro-display and said imaging optics is together adapted to form a virtual image which is observable through said viewing aperture of the diffractive beam expander in the first mode of operation. The combination of said micro-display and said imaging optics is together adapted to project said light beam onto an external screen in order to display a real image in the second mode of operation.

The virtual display mode allows viewing of images in privacy. On the other hand, the displayed real image may be viewed by two or more persons in e.g. meetings. Even when viewed by only one person, the real image displayed on an external screen allows ergonomic freedom of selecting a working position. The real image may be projected e.g. onto a white wall, onto the surface of a table, or onto a dedicated screen. The display device may be portable, lightweight and compact. A large detailed image may be examined at a glance in both operating modes.

Thanks to the use of the diffractive beam expander, the viewing aperture for a virtual image may be substantially enlarged without substantially increasing the weight and/or size of the display device.

In an embodiment, the display device comprises one or two diffractive beam expanders, which may be turned to the sides of the display device in order to select the operating mode. In another embodiment, the device comprises one or two diffractive beam expanders, which may slide with respect to the imaging optics in order to select the operating mode. Consequently, the display device may have a rather compact size in at least one of said operating modes.

In an embodiment, the display device is adapted to display a virtual image and to project a real image onto an external screen, at the same time.

The embodiments of the invention and their benefits will become more apparent to a person skilled in the art through the description and examples given herein below, and also through the appended claims.

### BRIEF DESCRIPTION OF THE DRAWINGS

In the following examples, the embodiments of the invention will be described in more detail with reference to the appended drawings, in which

FIG. 1 shows, in a three dimensional view, an optical engine and a diffractive beam expander adapted to expand a beam in one dimension,

FIG. 2 shows, in a three dimensional view, an optical engine and a diffractive beam expander adapted to expand a beam in two dimensions,

FIG. 3a shows, in a cross-sectional top view, a display device adapted to display a virtual image to a person,

FIG. 3b shows a real primary image on a micro-display,

FIG. 4 shows, in a cross-sectional top view, a diffractive beam expander, wherein the input beam passes through the substrate before impinging on the input grating,

FIG. 5 shows, in a cross-sectional top view, a diffractive beam expander having input and output gratings on different sides of the substrate,

FIG. 6 shows, in a cross-sectional top view, a diffractive beam expander having input and output gratings on the same side of the substrate,

FIG. 7 shows, in a cross-sectional top view, a bi-ocular display device adapted to display a virtual image to both eyes of a person,

FIG. 8 shows, in a three dimensional view, a bi-ocular display device,

FIG. 9 shows, in a top view, a bi-ocular display device having a non-zero angle between diffractive beam expanders,

FIG. 10 shows, in a cross-sectional top view, a bi-ocular display device having a diffractive beam expander to display a virtual image to both eyes of a person,

FIG. 11 shows, in a cross-sectional top view, a bi-ocular display device having two diffractive beam expanders to display a virtual image to the eyes of a person,

FIG. 12 shows, in a top view, a bi-ocular display device having two optical engines to display a stereoscopic virtual image to the eyes of a person,

FIG. 13a shows, in a top view, a display device adapted to display a virtual image,

FIG. 13b shows, in a top view, the display device of FIG. 13a adapted to project an image onto an external screen by sliding the beam expanders away from the front of the optical engine,

FIG. 14a shows, in a top view, a display device adapted to display a virtual image,

FIG. 14b shows, in a top view, the display device of FIG. 14a adapted to project an image onto an external screen by turning the beam expanders away from the front of the optical engine,

FIG. 15 shows, in a top view, a display device having detachable beam expanders,

FIG. 16a shows, in a three dimensional view, the display device of FIG. 8 adapted to project an image onto an external screen,

FIG. 16b shows, in a side view, a first operating mode of the device according to FIGS. 8 and 16a,

FIG. 16c shows, in a side view, a second operating mode of the device according to FIGS. 8 and 16a,

FIG. 17a shows, in a three dimensional view, a display device adapted to show a virtual image,

FIG. 17b shows, in a three dimensional view, the display device of FIG. 17a adapted to project an image on an external screen,

FIG. 18 shows, in a top view, an optical engine,

FIG. 19 shows, in a top view, coupling of an optical fiber into an optical engine,

FIG. 20 shows, in a cross-sectional top view, a display device comprising a prism to select the operating mode,

FIG. 21 shows, in a cross-sectional top view, a display device comprising a prism to implement a folded configuration,

FIG. 22 shows, in a three dimensional view, a display device adapted to project a real image and to display a virtual image at the same time,

FIG. 23 shows, in a top view, a display device adapted to project a real image and to display a virtual image at the same time,

FIG. 24 shows, in a top view, an input grating adapted to transmit a part of the input beam B0 without diffracting,

FIG. 25 shows, in a top view, an electrically configurable input grating, and

FIG. 26 shows, in a top view an optical switch based on frustrated total internal reflection.

### DETAILED DESCRIPTION

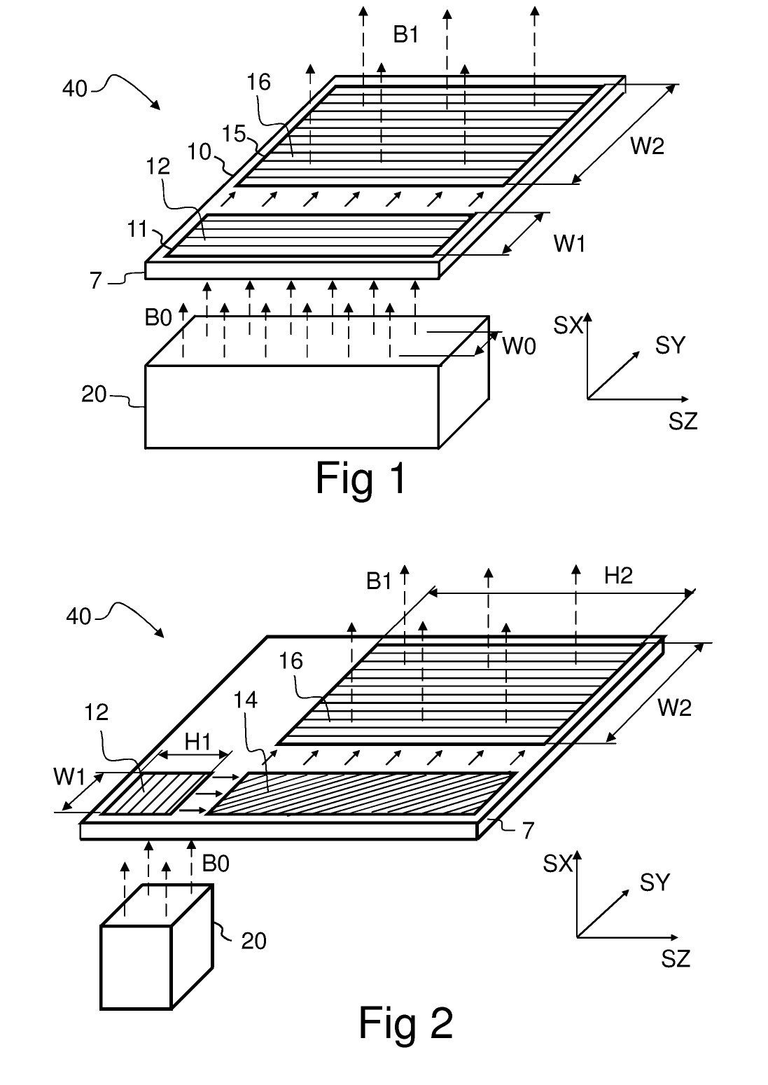

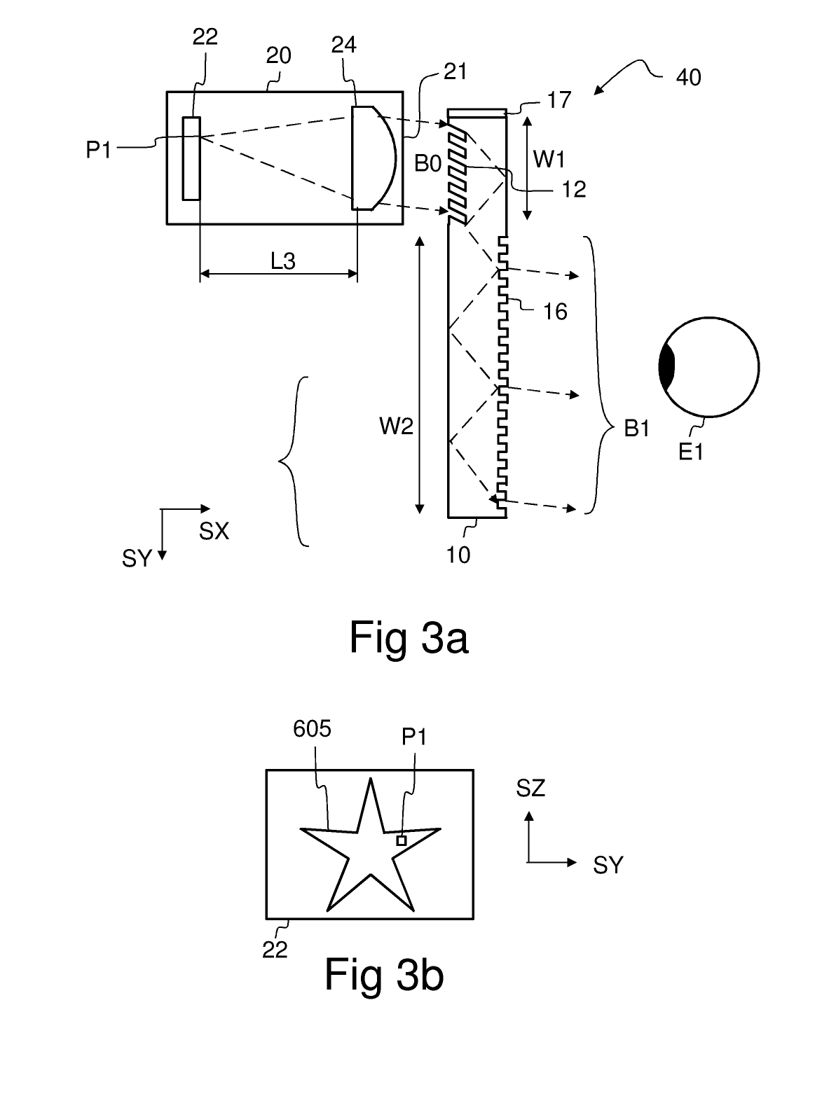

Referring to FIG. 1, a virtual display module 40 may comprise an optical engine 20 and a diffractive beam expander 10. The optical engine 20 comprises a micro-display 22 and imaging optics 24 (FIG. 3a). The virtual display module 40 converts a real primary image 605 (FIG. 3b) formed by the micro-display into a virtual image, which is observable through a viewing aperture 15 of the diffractive beam expander 10.

The diffractive beam expander 10 comprises an input grating 12 and an output grating 16 implemented on a common substantially transparent substrate 7. The upper and lower surfaces of the substrate 7 are substantially planar and substantially parallel. The substrate is waveguiding, which means that in-coupled light may propagate within said substrate 7 and such that said propagating light may be confined to said substrate 7 by total internal reflections. Light B0 impinging on the input grating 12 may be coupled into the substrate 7 such that it propagates within said substrate substantially in the direction SY. Said light is subsequently coupled out by the output grating 16 providing a beam B1. The output beam B1 propagates substantially in the same direction as the input beam B0.

The viewing aperture 15 is defined by the visible perimeter of the output grating 16. The input grating 12 has an input aperture 11, which is defined by the perimeter of the input grating 12. The width of the input aperture 11 is W1, and the width of the viewing aperture is W2.

The width of the output beam B1 is defined by the width W2 of the viewing aperture 15. The width of the output grating may be selected to be greater than the width W0 of the beam B0 provided by the optical engine 20. Consequently, the upper limit of the beam B1 is not limited to the width W0 of the exit pupil of the optical engine 20 and the diffractive beam expander 10 may expand at least one dimension of a light beam.

The width of the input grating may be selected to be greater than or equal to the width W0 of the beam of the optical engine 20, in order to maximize the brightness of the displayed virtual image.

The direction SX is perpendicular to the direction SY. The direction SZ is perpendicular to the directions SX and SY.

The apertures 11, 15 are defined by the perimeter of the gratings 12, 16. The apertures 11, 15 may also be smaller than the gratings 12, 16 if a mask is superposed on said gratings, e.g. in order to modify the visual appearance of the display module 40.

The gratings 12, 16 are diffractive elements, which may have a grating period d which is e.g. in the range of λ/2 to λ where λ is a visible wavelength of light. The visible range of wavelengths is generally considered to be 400 to 760 nm, and the grating period d may be e.g. in the range of 200 to 1520 nm, respectively. The gratings 12, 16 may be e.g. surface relief gratings implemented by molding or embossing. The gratings 12, 16 may also be holographic volume gratings. One or more gratings 12, 16 may also be embedded in the substrate 7. The display module 40 may also comprise more than two diffractive elements 12, 16.

Referring to FIG. 2, the diffractive beam expander 10 may comprise three gratings 12, 14, 16 to expand a light beam in two dimensions, as described e.g. in U.S. Pat. No. 6,580,529. The beam B0 of the optical engine 20 is coupled into the substrate 7 by the input grating 12. The beam is expanded in the direction SZ by an intermediate grating 14, and the beam is expanded in the direction SY by the output grating 16. The height H2 and the width W2 of the output grating 16 may be selected to be greater than the respective dimensions of the beam B0 in order to provide beam expansion in two dimensions. The width W2 of the output grating 16 may be selected to be greater than the width W1 of the input grating 12, and the height H2 of the output grating 16 may be selected to be greater than the height H1 of the input grating, in order to maximize the brightness of the displayed virtual image.

Referring to FIG. 3a, the optical engine 20 comprises a micro-display 22 and imaging optics 24. The imaging optics 24 may comprise one or more optical elements, such as lenses, mirrors, prisms or diffractive elements. Light rays transmitted from a point P1 of the micro-display 22 are collimated by the imaging optics 24 to form parallel rays of light, which constitute the beam B0 provided by the optical engine 20. The distance L3 between the micro-display 22 and the imaging optics 24 is set such that the pixels of the micro-display 22 are substantially at the focal distance of the imaging optics 24. A plurality of beam B0 are provided in order to display images, which consist of a plurality of pixels.

The at least one beam B0 transmitted from the output aperture 21 of the optical engine 20 impinges on the input grating 12 of the diffractive beam expander 10. The beam B0 is at least partially intercepted by the input grating 12, and at least a part of the light of the beam B0 is coupled into the waveguide 7 by the input grating 12. The output grating 16 diffracts an expanded beam B1 towards the eye E1 of an observer.

The viewing aperture 15 of the grating 16 substantially defines the maximum height H2 and width W2 of the expanded light beam B1.

The diffractive beam expander 10 may be mono-ocular, i.e. it may have only one output grating 16. The expander 100 may comprise a slanted input grating 10 to increase the efficiency of coupling light towards the output grating, when compared with e.g. a binary grating having a straight rectangular profile. The input grating 12 may be adapted to diffract e.g. more than 50% of the power of the in-coupled light towards the output grating 16. The input grating 12 may be e.g. a slanted surface relief grating.

Also the output grating 16 may be slanted in order to enhance coupling of light out of the substrate of the diffractive beam expander 10, when compared with e.g. a binary grating having a straight rectangular profile.

The diffractive beam expander 10 may comprise an optical absorber 17 to absorb in-coupled light, which propagates in the wrong direction, i.e. in the direction opposite to SY. Transmission or reflection of said light at the end of the expander 10 may create adverse stray light effects, in particular when the expander is in contact with other optical components. The absorber may be e.g. a piece of absorbing glass or plastic. The absorber may be a black coating. The edge of the substrate 7 may also be chamfered to direct light into a harmless direction.

FIG. 3b shows a real primary image 605 formed on the micro-display 22. The primary image 605 may consist of a plurality of light-transmitting points P1 or pixels.

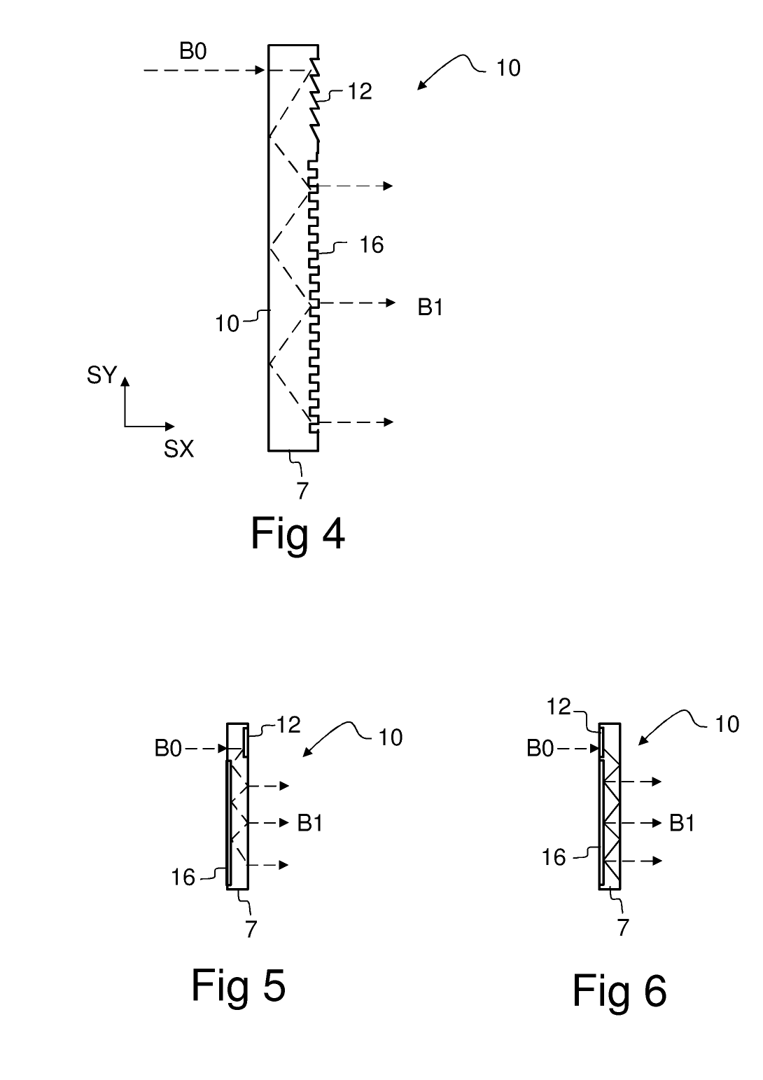

Referring to FIG. 4, the input grating may also be a blazed surface relief grating adapted to diffract more than 50% of power of the in-coupled light towards the output grating 16. The incoming beam B0 may be transmitted through the substrate 7 before impinging on the input grating 12. The input grating 12 and the output grating 16 may be on the same planar surface of the substrate 7.

Referring to FIG. 5, the input grating 12 and the output grating 16 may be on different planar surfaces of the substrate 7, wherein the incoming beam B0 may be transmitted through the substrate 7 before impinging on the input grating 12. Referring to FIG. 6 the input grating 12 and the output grating 16 may be on the same planar surfaces of the substrate 7, wherein the out-coupled beam B1 is transmitted through the substrate 7.

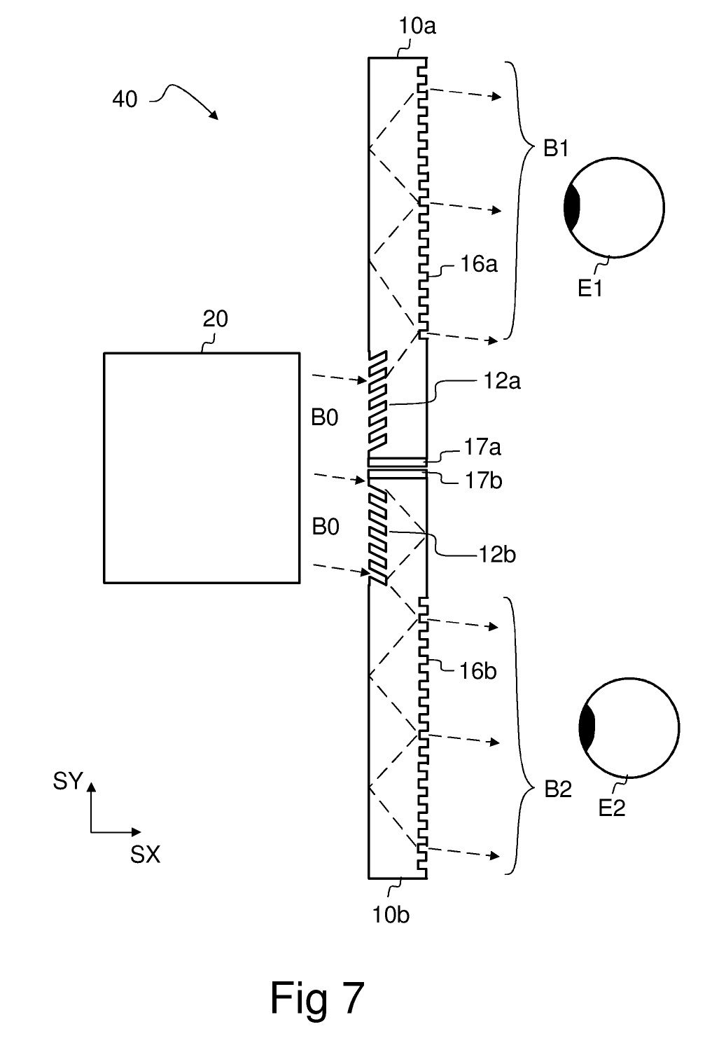

Referring to FIG. 7, the virtual display module 40 may comprise two or more diffractive beam expanders 10a, 10b, e.g. in order to implement a bi-ocular virtual display module 40. The first beam expander 10a comprises an input grating 12a and an output grating 16a. The second beam expander comprises an input grating 12b and an output grating 16b. The beam B0 of an optical engine 20 may impinge simultaneously on both input gratings 12a, 12b. The first output grating 16a may provide first output beam B1 towards the right eye E1 of a viewer, and the second output grating 16b may provide a second output beam B2 towards the left eye E2 of the viewer.

The display module 40 may comprise one or more optical absorbers 17a, 17b to minimize stray light effects, in particular to minimize stray light effects caused by light escaping from one beam expander 10a to another 10b.

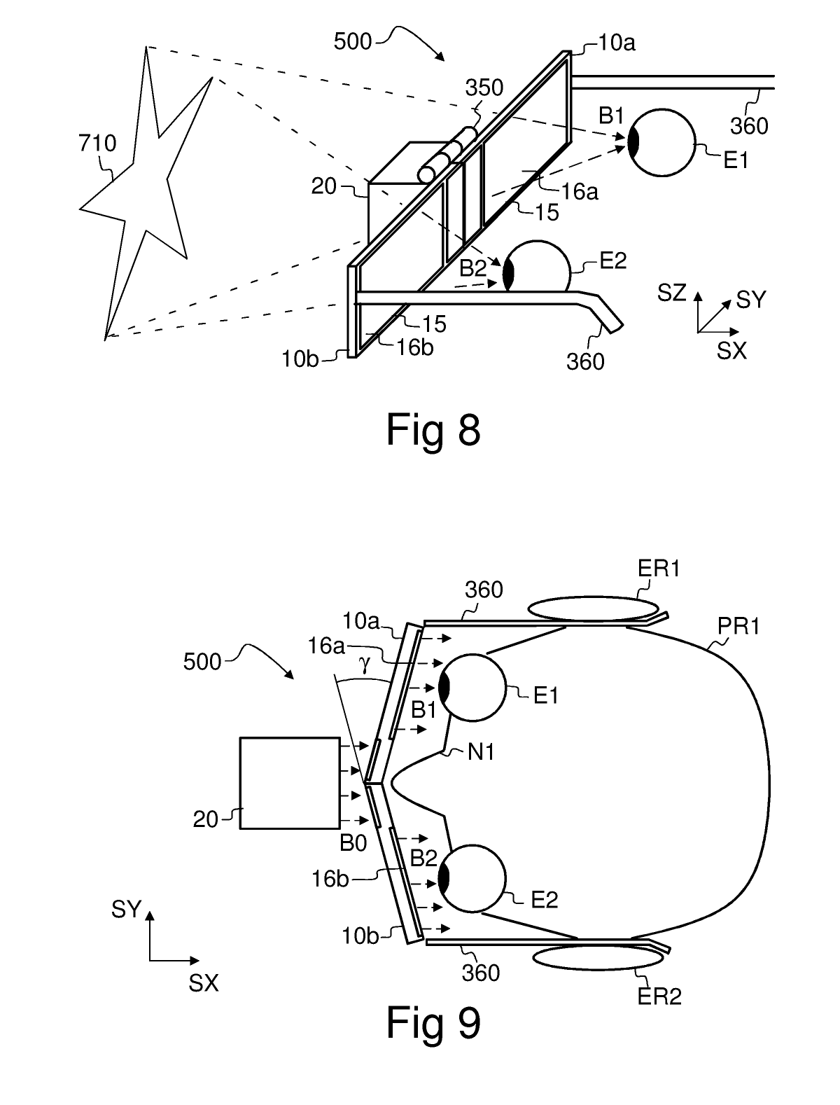

Referring to FIG. 8, a display device 500 may comprise an optical engine 20, a first diffractive beam expander 10a, and a second diffractive beam expander 10b in order to implement a bi-ocular virtual display device. The light beams B1, B2 provided by the diffractive expanders 10a, 10b provide for a viewer an impression of a virtual image 710 displayed at an infinite distance from the viewer. The virtual image 710 may be e.g. a star pattern, as shown in FIG. 8.

The device 500 may comprise a hinge mechanism 485 to allow change of the operating mode from a virtual display mode to a projecting mode.

Referring to FIG. 9, the display device 500 may further comprise earpieces 360 to facilitate positioning of the beam expanders 10a, 10b in front of the eyes E1, E2 of a person PR1. Said earpieces 360 may be positioned on the ears ER1, ER2 of said person PR1.

There may be a non-zero angle γ between the planes of the output gratings 16a, 16b in order to allow room for the nose N1 of the person PR1. The angle γ may be e.g. in the range of 3 to 20 degrees. The perimeter 15 of the output gratings 16a, 16b may allow a wider angular field of view when the gratings 16a, 16b are closer to the eyes E1, E2 of the person PR1. The beam expanders 10a, 10b may block ambient light more efficiently. Also the weight of the display device 500 may be distributed more conveniently on the nose N1 and on the ears ER1, ER2.

The device 500 may also be attached to a headgear, e.g. to a helmet.

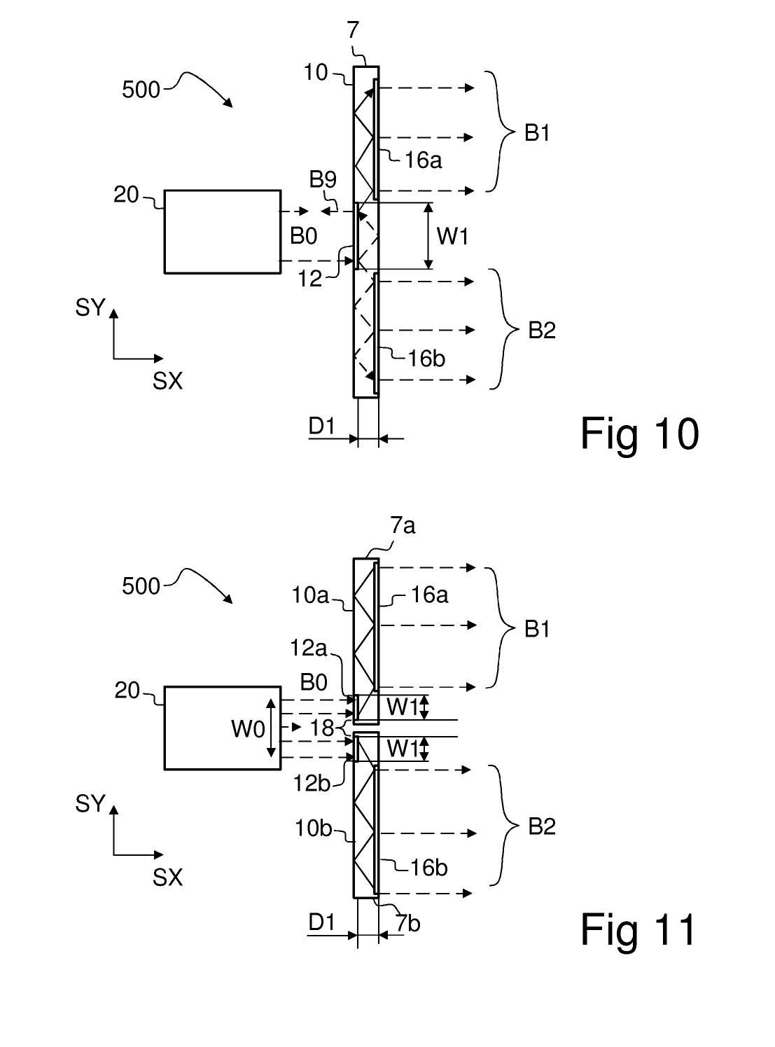

Referring to FIG. 10, the display device 500 may comprise a diffractive beam expander 10 which has two output gratings 16a, 16b implemented on a common substrate 7. A common input grating 12 splits and directs the light of the in-coupled light towards the first output grating 16a and also towards the second output grating 16b.

W1 denotes the width of the input grating 10 and D1 denotes the distance between the input grating 10 and the opposite surface of the planar waveguide 5. D1 may be substantially equal to the thickness of the substrate 7. W1 may be greater than or equal to the width of the beam B0 in order to maximize coupling efficiency.

The ratio of the width W1 to the distance D1 may be selected to be smaller than or equal to a predetermined limit in order to minimize light out-coupling by the input grating 12. If the ratio of the width W1 to the distance D1 is greater than said predetermined limit, then a fraction of in-coupled light may be coupled again out of the substrate 7 by the input grating 10, as shown by the beam B9. This may lead to a reduction in the efficiency of coupling light into the substrate 7. Said predetermined limit may be calculated by using the wavelength of the beam B0, the grating constant of the input grating 12, and the refractive index of the substrate 7.

The substrate 7 may also comprise a polarization rotating film in order to increase coupling efficiency, in particular when the ratio W1/D1 is greater than said predetermined limit. The use of a polarization rotating film for said purpose has been described in the patent application US 2005/0002611.

Referring to FIG. 11, the display device 500 may alternatively comprise two diffractive beam expanders 10a, 10b. The width W1 of each input grating 12a, 12b may be selected to be smaller than or equal to the predetermined limit mentioned above with reference to FIG. 10. The sum W1+W1 of the widths of the input gratings 12a, 12b may be substantially greater than in the case of a single input grating 12 of FIG. 10 while the backwards-coupling may still be avoided. The beam B0 of the optical engine 20 may be wider than in the case of FIG. 10 while preserving almost the same coupling efficiency. Consequently, the use of the two separate expanders 10a, 10b may facilitate reducing power consumption in the optical engine 20. This is an important aspect if the power is supplied from a battery.

The width of an ineffective portion 18 between the input gratings 12a, 12b may be minimized when maximizing the coupling efficiency of the beam B0 into the beam expanders 10a, 10b.

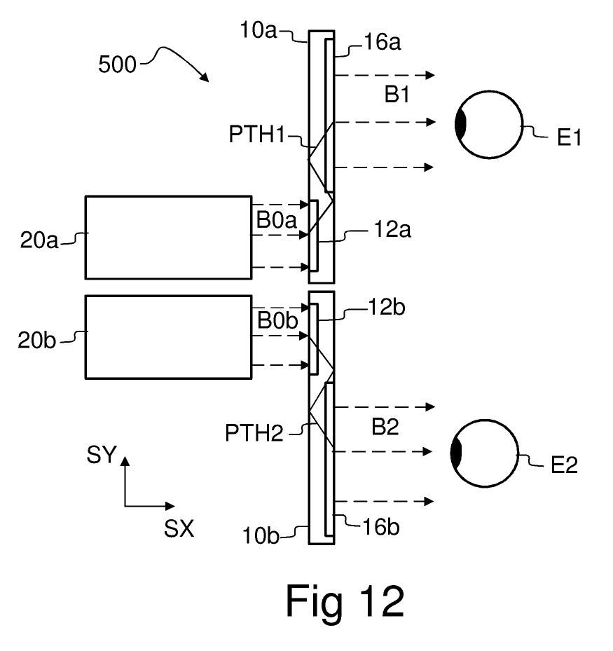

Referring to FIG. 12, the display device 500 may comprise two separate optical paths PTH1, PTH2 in order to show stereoscopic virtual images to a viewer. Light may be transferred through the first optical path PTH1 in order to display a first virtual image to the right eye E1, and light may be transferred through the second optical path PTH2 in order to show a second virtual image to the left eye E2. The first virtual image shown to the right eye E1 may be slightly different than a second virtual image shown to the left eye E2 such that the viewer may perceive a stereoscopic impression.

The display device 500 may comprise e.g. separate optical engines 20a, 20b having separately controlled micro-displays 22, and separate diffractive beam expanders 10a, 10b in order to display stereoscopic virtual images to a viewer.

The diffractive beam expanders 10, 10a, 10b may also be at least partially transparent, allowing the user to see his environment through the diffractive beam expanders 10a, 10b while also viewing a displayed virtual image 710.

Stereoscopic virtual images may be displayed by using two partially transparent diffractive beam expanders. This arrangement may be applied especially in augmented reality systems.

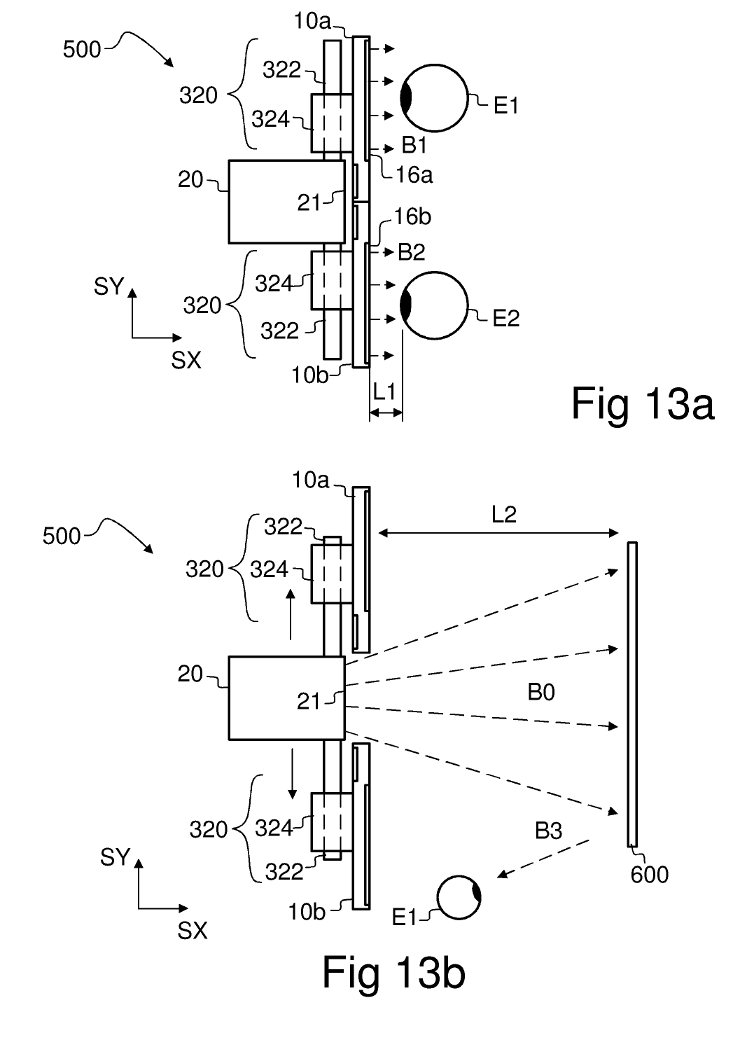

Referring to FIG. 13a, the display device 500 may comprise one or more slide mechanisms 320 to move at least one diffractive beam expander 10a, 10b with respect the output aperture 21 of the optical engine 20. A slide mechanism 320 may comprise e.g. one or more guideways 322 and one or more sliding counterparts 324. A counterpart 324 may be e.g. a cylindrical or rectangular bushing.

In a first mode of operation, i.e. in a virtual display mode, the input gratings 10a, 10b are positioned to intercept the beam B0 transmitted from the aperture 21 of the optical engine 20. The expanders 10a, 10b provide expanded beams B1, B2, which in turn provide the impression of a virtual image to the eyes E1, E2 of a viewer.

The display device may be used e.g. such that the distance L1 between the output gratings 16a, 16b and the eyes E1, E2 may be e.g. in the range of 2 mm to 100 mm. The display device 500 may also be positioned farther away from the eyes E1, E2, e.g. at a distance in the range of 0.1 to 1 meters, but in that case the perimeter of the output gratings 16a, 16 may limit the field of view.

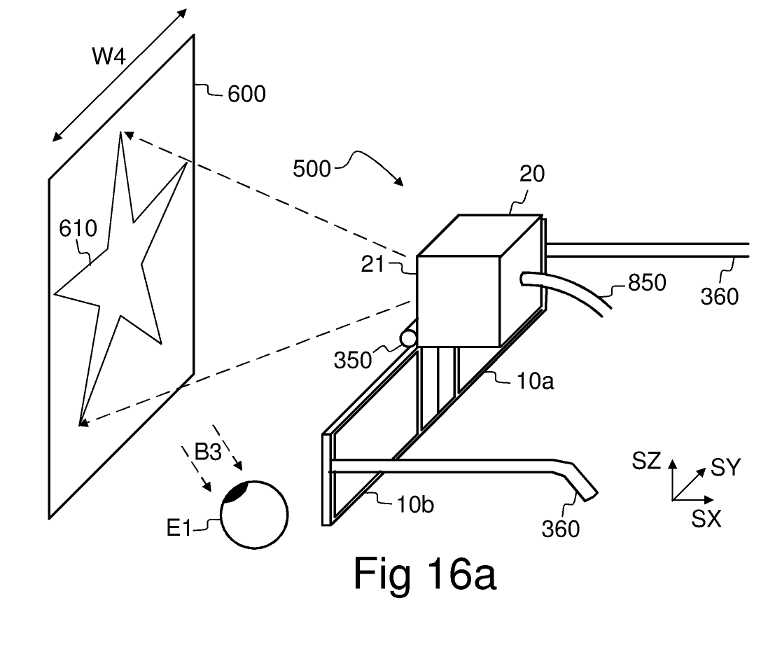

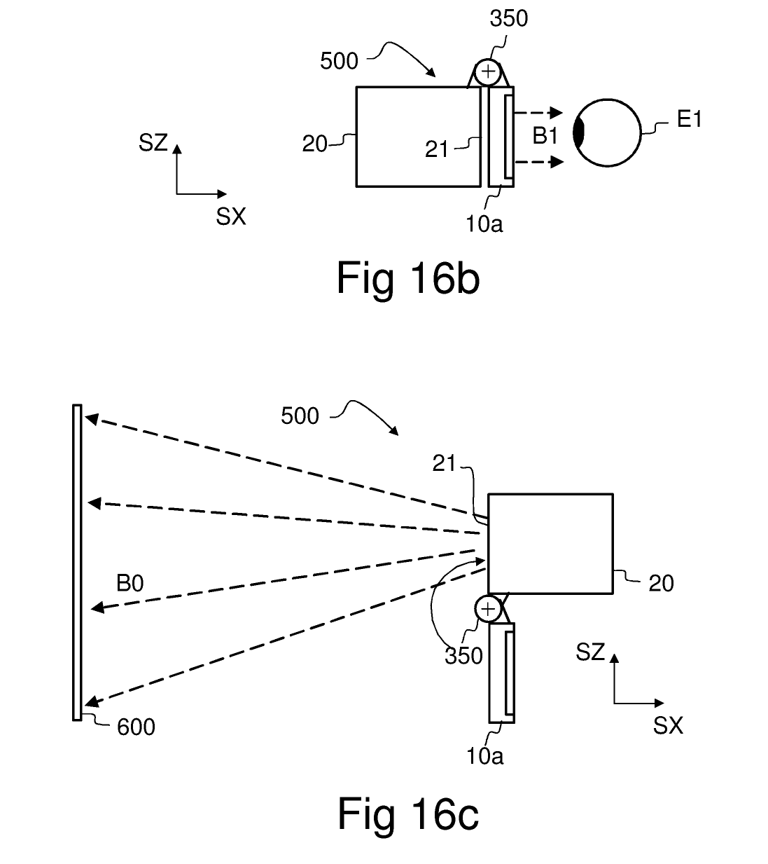

FIG. 13b shows a second mode of operation of the display device 500 according to FIG. 13a, i.e. a projecting mode, wherein the display device 500 is adapted to project a real image 610 on an external screen 600 (FIG. 16a). The diffractive beam expanders 10a, 10b are at least partially moved with respect to the output aperture 21 of the optical engine 20 such that they do not substantially obstruct the beam B0 provided by said output aperture 21. Consequently, the beam B0 may impinge on an external screen 600 in order to create a real image 610 on said screen 600. The screen 600 may be e.g. a white surface. The eye E1 of a viewer sees the light B3 scattered from the surface of the external screen 600. The distance L2 between the display device 500 and the screen may be e.g. in the range of 0.1 m to 20 m.

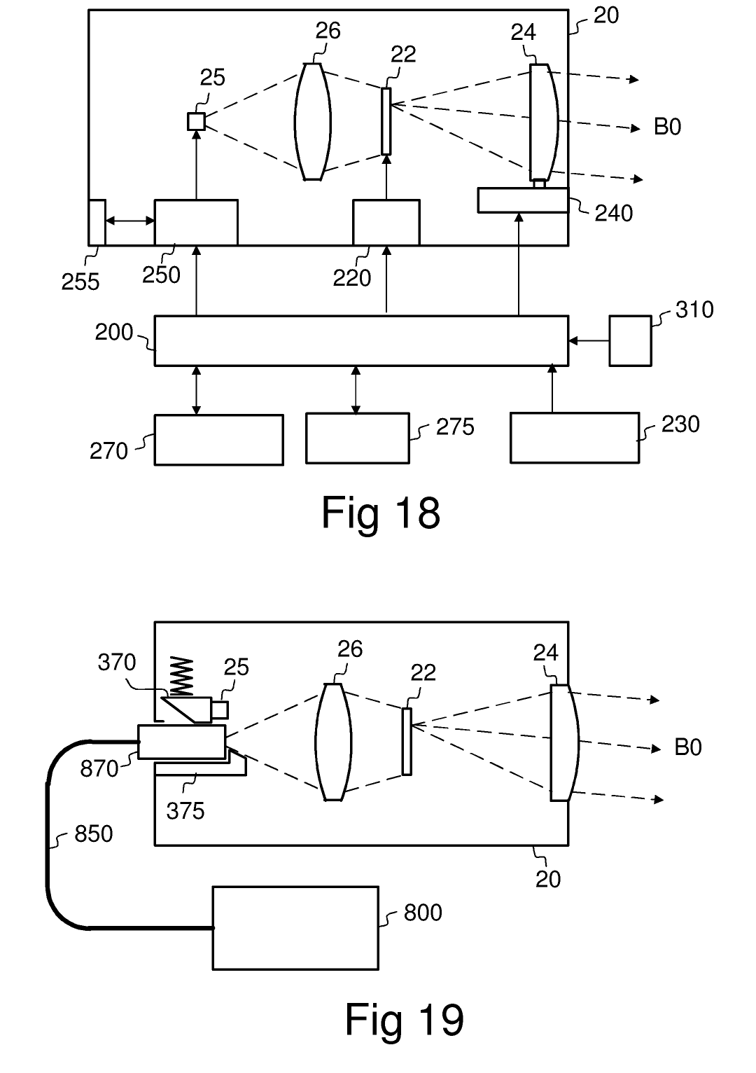

In the virtual display mode, the optical engine 20 is adapted to provide a substantially collimated beam B0 for each illuminated pixel of the micro-display 22. The output beam B0 may be focused in order to provide a sharp real image in the projecting mode. The focusing may be accomplished by e.g. by adjusting the distance L3 between the micro-display 22 and imaging optics 24 (FIG. 3a). The optical engine 20 may comprise a focusing actuator (FIG. 18) to move the imaging optics 24 and/or the micro-display 22.

An additional optical element, e.g. a further lens may be positioned to or removed from the optical path in order to affect the focusing of the beam B0. Such an additional lens may be attached or integrated to the input grating 12a, 12b of the diffractive beam expander 10a, 10b. Electrically deformable lenses may be used.

The beam B0 is substantially collimated in the virtual display mode. The beam B0 may remain to be substantially collimated also in the projecting mode, but in that case the resolution of the displayed real image is limited to the width W0 of the beam B0. However, this may be adequate in some applications, especially when the width of the beam B0 is small when compared with the width W4 of the displayed real image (FIG. 16a).

Thanks to the slide mechanism 320, the distance between the beam expanders 10a, 10b may be slightly adjusted, in order to correspond to different interpupillary distance of different users, i.e. to different distance between the pupils of the eyes E1, E2 of a user.

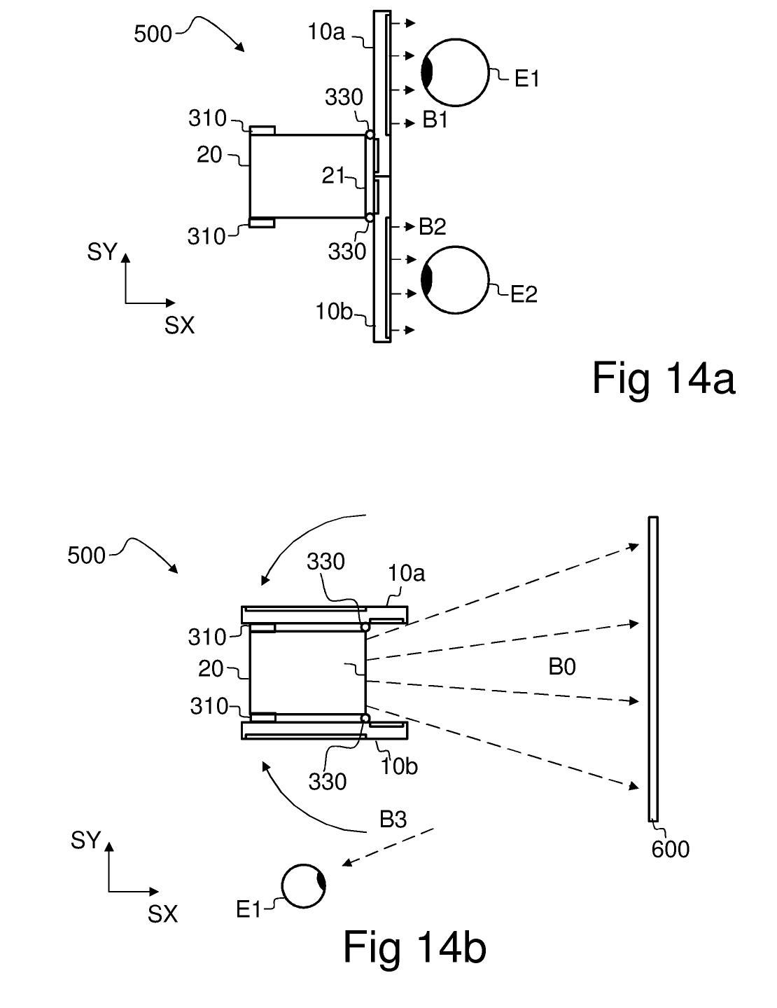

Referring to FIG. 14a, the display device 500 may comprise one or more hinges 330 to move at least one diffractive beam expander 10a, 10b with respect the output aperture 21 of the optical engine 20, by a pivoting movement. FIG. 14a shows the display device 500 in the virtual display mode.

FIG. 14b shows the device of FIG. 14a in the projecting mode. The diffractive beam expanders 10a, 10b may be pivoted about the hinges 472 such that the expanders 10a, 10b do not substantially obstruct the beam B0 provided by the output aperture 201.

The display device 500 may further comprise one or more position sensors 310 to sense the position of at least one diffractive beam expander 10a, 10b with respect to the output aperture 21 of the optical engine 200. The position sensors 310 may be used e.g. in the adjustment of the optical power of the beam B0 such that a high operating power of the projecting mode is enabled only if the sensors 310 sense that both expanders 10a, 10b are fully removed from the path of the beam B0. Thus, the sensors 310 may be used to implement a safety feature. The sensors 310 may be e.g. optical or electromechanical switches. The switches may e.g. provide a signal to a control unit 200 (FIG. 19), or they may directly bypass a power-limiting resistor (not shown).

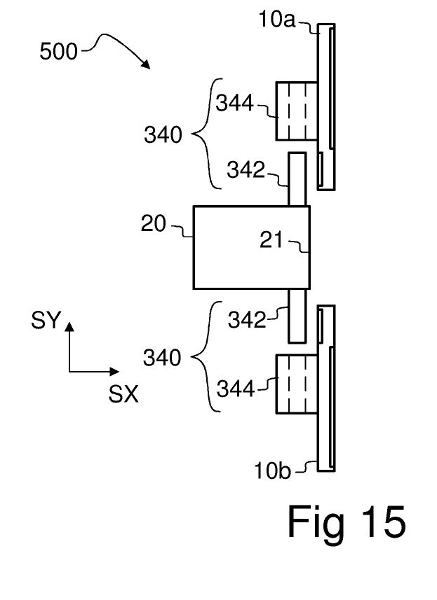

Referring to FIG. 15, the diffractive beam expanders 10a, 10b may also be detachable in order to enable or disable the projecting mode. The display device 500 may comprise a connecting mechanism 340 to attach the beam expanders 10a, 10b to the front of the output aperture 21.

Consequently, the diffractive beam expanders 10a, 10b could be delivered as separate accessories and attached to the optical engine 20 by an end user.

FIG. 16a shows the display device 500 of FIG. 8 in the projecting mode. FIG. 8 showed the same display device in the virtual display mode. In the projecting mode, the output aperture of the optical engine 20 has been moved with respect to the diffractive beam expanders 10a, 10b such that the expanders do not obstruct the beam B0 transmitted from the output aperture 21 of the optical engine 20. An observer may see a real image 610 displayed on an external screen 600. The width of the real image 610 is W4.

The display device 500 may comprise a hinge 350 to move the optical engine 20 with respect to the beam expanders 10a, 10b. The hinge 350 may also be used to manually adjust the desired vertical position of the displayed image 610, provided that said hinge 350 has adequate friction to enable the selection of intermediate mechanical positions.

The earpieces 360 may be adapted to act as a base or stand for the display device 500. The horizontal position of the displayed image 610 may be selected by horizontally turning the whole display device 500.

FIG. 16b shows the display device 500 of FIGS. 8 and 16 a in the virtual display mode. The diffractive beam expanders 10a, 10b are positioned in front of the aperture 21 of the optical engine 20 in order to enlarge the exit pupil 21 of the optical engine 20.

FIG. 16c shows the display device 500 of FIGS. 8 and 16a in the projecting mode. The diffractive beam expanders 10a, 10b have been moved away from the front of the output aperture 21. The orientation of the displayed image may be automatically or manually selectable, respectively, in order to avoid an image, which is upside down.

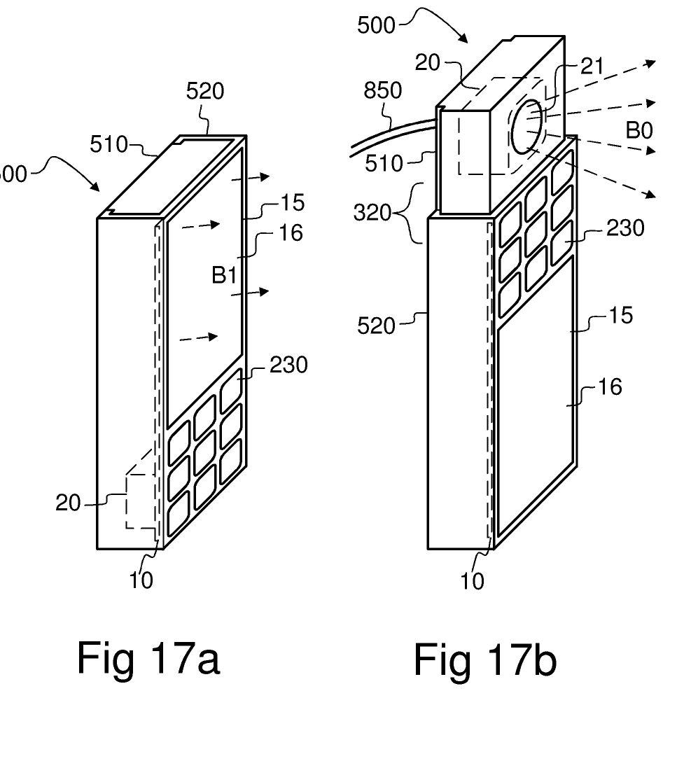

Referring to FIG. 17a, a display device 500 may have a diffractive beam expander 10 to enlarge the beam provided by the optical engine 20. In the virtual display mode, as shown in FIG. 17a, the diffractive beam expander 10 covers the output aperture of the optical engine 20, and the beam B1 provided by the output grating 16 corresponds to a virtual image displayed at infinity. The distance between the display device 500 and the user's eyes may be e.g. in the range of 2 to 100 cm.

The display device 500 may have a body 510 and cover 520, which cover 520 is adapted to be movable with respect to the body 510 by a slide mechanism. The slide mechanism may comprise e.g. grooves and ridges. The optical engine 20 may be attached to the body 510 and the beam expander 10 may be attached to the cover 520.

The display device 500 may further comprise a key set 230.

FIG. 17b shows the display device 500 of FIG. 17a in the projecting mode. Now, the diffractive beam expander 10 has been moved away from the front of the aperture 21, leaving the beam B0 unobstructed. Consequently, a real image 610 may be projected on a remote screen 600 (FIG. 16a).

If desired, the display device 500 may be positioned e.g. upside down on a supporting surface, e.g. on a table. The orientation of the displayed image may be automatically or manually selectable, respectively.

An optical fiber 850, or a power cable may be attached to the display device 500 in order to supply extra power, which may be needed in the projecting mode. The beam B0 may be refocused in order to attain a sharp image.

The display device 500 may also have a third operating mode, a private virtual display mode, in contrast to the more public virtual display mode of FIG. 16a. Outsiders may namely see a glimpse of a virtual image if the output grating 16 is large and if the device 500 is held far away from the eyes. In the third operating mode, the user may position the output aperture 21 near his/her eye, and use the optical engine 20 directly as a virtual display. In other words, the virtual image 710 may also be observed without using the diffractive beam expander 10.

Referring to FIG. 18, the optical engine 20 may comprise a light source 25, a condenser 26, a micro-display 22, and an imaging optics 24. In addition, there may be an external power connector 255, a light source driver 250, a display driver 220, a focusing actuator 240, a control unit 200, a data communications unit 270, a memory unit, a position sensor 310, and a key set 230.

The condenser 26 concentrates light emitted by the light source 25 towards the micro-display 22. The light source may be e.g. a laser, light emitting diode, a gas discharge lamp, incandescent lamp, or a halogen lamp. The condenser may comprise one or more lenses, mirrors, prisms or diffractive elements. The micro-display 22 may be e.g. a liquid crystal display or an array of micromechanically movable mirrors. Also a reflective arrangement may be used instead of the transmissive shown in FIG. 18. The expression “micro” means herein that the display is smaller than the display device 500. The micro-display 22 may also be an array of light emitting diodes, in which case the light source 25 and the condenser 26 may be omitted. The width of the micro-display may be e.g. smaller than or equal to 25 mm.

The imaging optics 24 collimates or focuses light sent by the pixels of the micro-display 22, thereby forming the beam B0 provided by the optical engine 20.

The control unit 200 may control the power and the operation of the light source 25 by controlling the light source driver 250. If additional electrical power is needed in the projecting mode, it may be supplied via the power connector 255. The control unit 200 may control the displayed image via the display driver 220. The control unit 200 may adjust the focusing or collimation via the focusing actuator 240. The focusing actuator 240 may move the imaging optics 24, and/or the micro-display. The focusing actuator 240 may also insert or remove a further optical element into/from the optical path between the micro-display 22 and the imaging optics, or into/from between the imaging optics 24 and a beam expander 10. The actuator 240 may be e.g. a piezoelectric actuator. Said further optical element may be e.g. a convex lens, concave lens or a planar plate of transmissive material.

The control unit 200 may be in connection with the data communications unit 270, the memory unit 275, the position sensor 310, and the key set 230.

The position sensor provides information on the position of the beam expander 10 with respect to the optical engine 20. This information may be used e.g. for adjusting the power of the lamp, focusing, and the orientation of the image. The user may give commands by the key set 230 to the control unit 200. The key set 230 may be e.g. a keypad or a keyboard. The data communications unit 270 may e.g. provide access to the internet or to a local area network, e.g. by radio frequency or optical communication. The memory unit 275 provides memory for storing e.g. video clips.

The optical engine 22 may comprise only the micro-display 22, imaging optics 24, and the actuator 240. One or more of the above-mentioned components and units may be attached to the optical engine 20 by an optical and/or electrical cable. This may help to save weight, especially in case of the goggle-type display devices 500 of FIG. 8 and FIG. 9.

The maximum optical power, i.e. the maximum luminous flux of the optical engine 20 may be substantially increased in the projecting mode when compared with the luminous power of the optical engine in the virtual display mode. The maximum luminous flux of the optical engine 20 may be e.g. in the range of 0.1 to 1 lumen in the virtual display mode and in the range of 1 to 100 lumen in the projecting mode. A luminous power in the order of 100 lumens may be provided e.g. by using a white light emitting diode (LED) of 4 W electrical power as the light source 25. In order to project images to a large audience, the maximum luminous flux of the optical engine 20 may even be in the range of 100 to 10 000 lumens in the projecting mode.

Instead of adjusting the optical power of the beam B0, i.e. instead of adjusting the luminous flux of the optical engine 200, the diffractive beam expanders 10, 10a, 10b may comprise one or more light-absorbing layers, portions or components to reduce the brightness of the displayed virtual image displayed through the diffractive beam expander.

Referring to FIG. 19, further optical power may be needed in the projecting mode. This further optical power may be supplied by an external light source 800. The further optical power may be guided by an optical fiber 850 having a plug 870 on its end. The plug 870 may be inserted into a connector 375 on the side of the optical engine 20 to replace the light source 25. The optical engine 20 may comprise e.g. a wedge mechanism 370 to move the light source 25 away from the way of the plug 870, in order to allow insertion of the light-emitting end of said plug 870 to the original position of the light source 25.

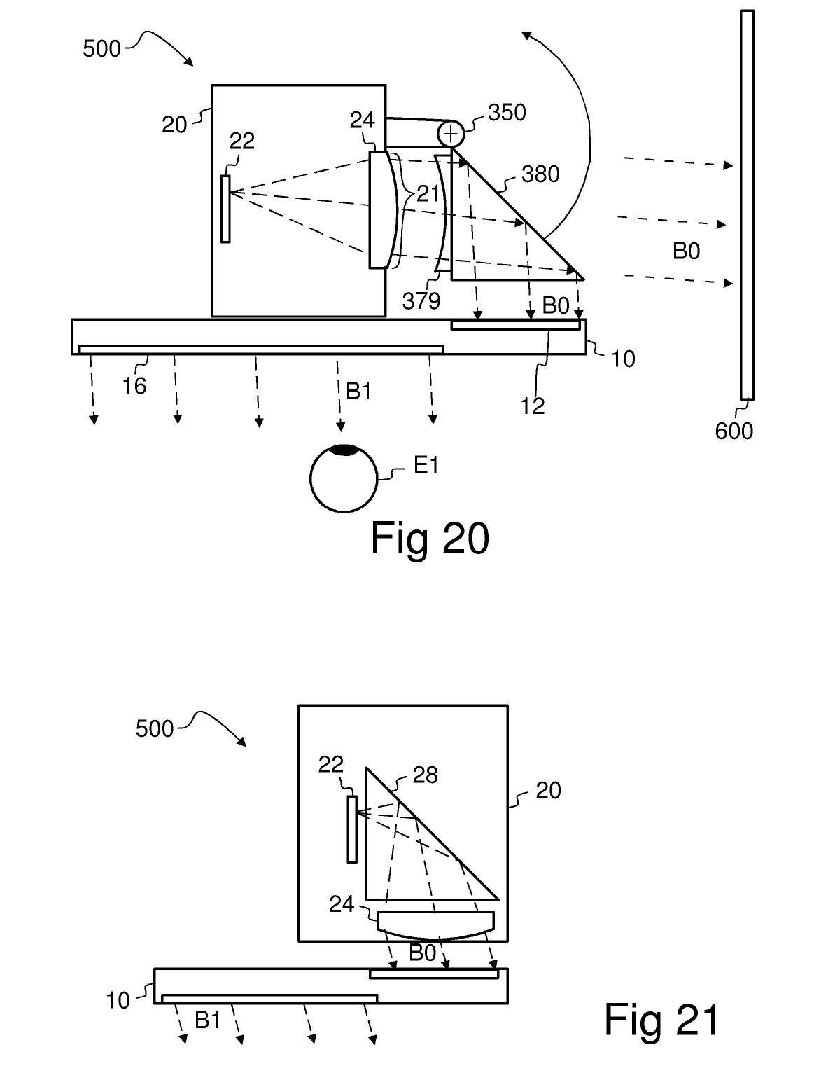

Referring to FIG. 20, the display device 500 may comprise a movable prism 380 or a mirror to switch between the virtual display mode and the projecting mode. The prism or the mirror may be movable with respect to the output aperture 21 of the optical engine 20. The prism 380 may be connected to the optical engine 20 by a hinge 350. Turning of the prism 380 counterclockwise upwards switches the operating mode from the virtual display mode to the projecting mode.

The display device 500 may comprise an optical element 379, e.g. a concave lens to re-collimate a focused beam B0 before it impinges on the input grating 12. The optical element 379 may be attached e.g. to a movable prism 380 or a mirror, as shown in FIG. 20, or to the diffractive beam expander 10.

The diffractive beam expander 10 may comprise e.g. a concave lens to collimate the beam B0 before it impinges on the input grating 12 of the diffractive beam expander 10.

Referring to FIG. 21, the display device 500 may comprise one or more prisms 28 or mirrors to implement a folded optical path and to make the device more compact. A prism 28 may be e.g. between the micro-display 22 and the imaging optics 24.

The diffractive beam expander 10 or expanders 10a, 10b may be positioned completely into the path of the light beam B0 and/or the diffractive beam expanders 10a, 10b may also be completely removed from the path of the light beam B0.

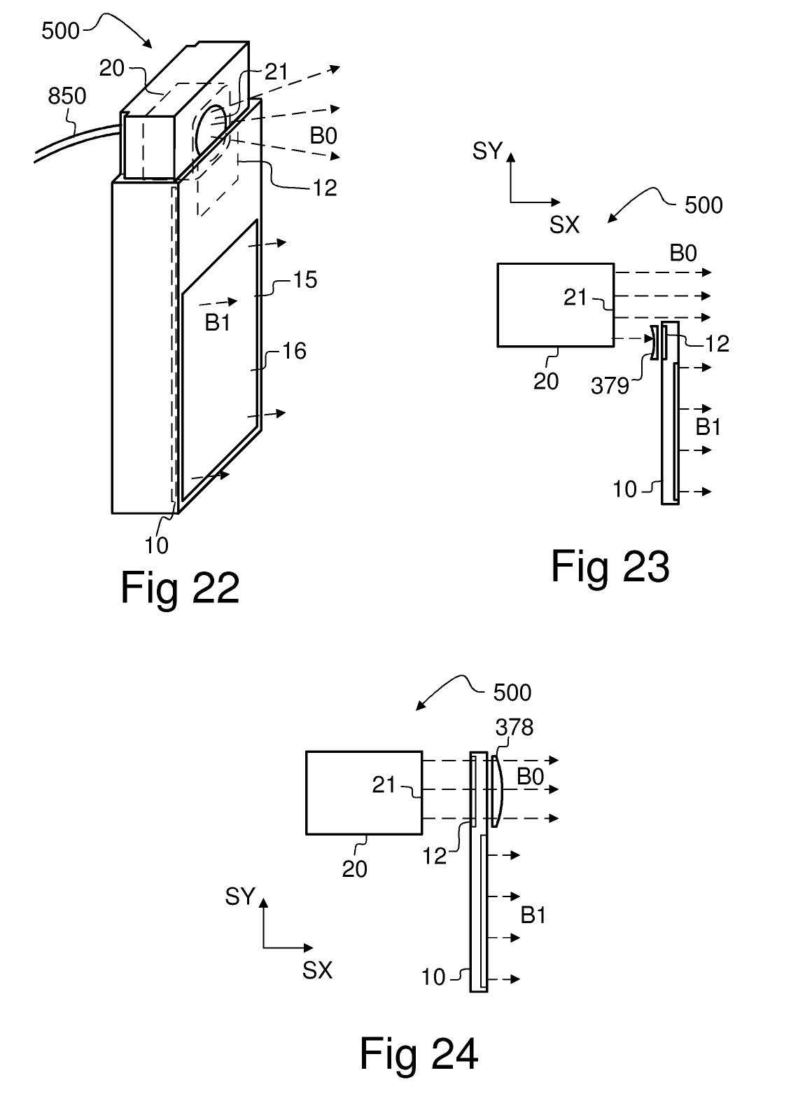

However, referring to FIG. 22, it should be noticed that the diffractive beam expander 10 may also be positioned only partially into the path of the light beam B0 in order to enable simultaneous displaying of a real image and a virtual image. For example, the input grating 12 of a diffractive beam expander 10 may intercept e.g. only 5% of the area of the light beam B0. The remaining 95% portion of the beam B0 may propagate substantially unobstructed to form a real image on the external screen 600, wherein the intercepted 5% portion of the beam B0 may be simultaneously enlarged by the diffractive beam expander 10 in order to display a virtual image to the user. Consequently, a person giving a presentation in front of an audience does not need to turn his head in order to look at the real image displayed to the audience, because he may see the corresponding virtual image in front of him.

It should be noticed that selecting between a virtual display mode and a projecting mode may not be necessary when the device simultaneously displays the virtual image and the projected real image.

However, the embodiment of FIG. 22 may be used to further increase the versatility of the display device 500 according to e.g. FIGS. 17a and 17b. The cover 520 may be slid into an intermediate position with respect to the body 510 in order to enable simultaneous viewing of the virtual and real images. Thus, the user may use the virtual image for monitoring the real image displayed onto a screen behind his back.

FIG. 23 shows how the input grating 12 of the diffractive beam expander 10 may partially intercept the beam B0. The device 500 may further comprise a collimating element 379 positioned between the output aperture 21 of the optical engine 20 and the input grating 12.

Referring to FIG. 24, a part of the input beam B0 may be transmitted through the input grating 12 without being diffracted. Thus, the input grating 12 may intercept the beam only partially although said input grating 12 covers the whole area of the beam B0. The intercepted portion of the beam B0 may be enlarged by the diffractive beam expander 10 to provide an expanded output beam B0. The remaining portion of the beam B0 may be projected to the external screen 600 to display a real image 610. The backside of the expander 10 may comprise a focusing element 378, e.g. a lens to focus the beam B0 after it has been transmitted through the diffractive beam expander 10.

The virtual display mode and the projecting mode of the device 500 may be selected by changing a state of at least one optical component. The state of an optical component comprises the position of said optical component. However, the state of an optical component may also be changed without a changing its position.

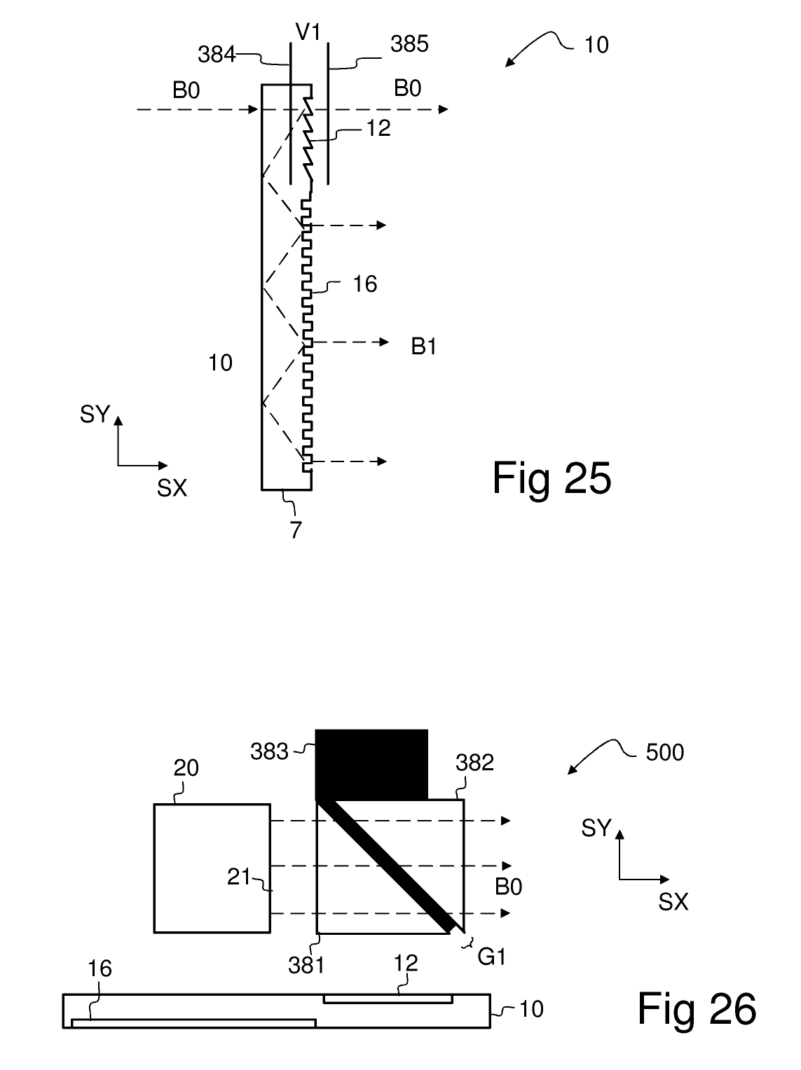

Referring to FIG. 25, the profile and/or the profile height of the input grating 12 may be electrically configurable, as disclosed e.g. in the Patent Application US20040109234 or in the Patent Application US20040201891. For example, the input grating 12 may comprise substantially transparent electrode structures 384, 385 such that a voltage V1 may be applied over said electrode structures to change the height of the grating profile of the input grating 12, in order to change its diffraction efficiency. A change in the profile and/or in the profile height may change the diffraction efficiency. Consequently, the input grating 12 may be set into a substantially diffracting state or into a substantially transmitting state. The ratio of a diffracted portion of the beam B0 enlarged by the expander 10 and a transmitted portion projected to the screen 600 may be adjusted by using an electrically configurable input grating 12.

Referring to FIG. 26 the device 500 may comprise an optical switch having e.g. a first prism 381 and a second prism 382. When the gap G1 is filled with a gas, the beam B0 may be reflected towards the input grating 12 of the expander 10 by total internal reflection. When the gap G1 is filled with a liquid 383 having a greater refractive index than said gas, the total internal reflection may be frustrated, and the beam B0 may be transmitted through the prisms 381, 382 as shown in FIG. 26. The liquid 383 may be moved e.g. by an electrostatic force or by using an actuated piston. Thus, the prism 381 may be set to a reflecting state or to a transmitting state.

The prism 381 may be set to a reflecting state or to a transmitting state also without the liquid 383, by moving the position of the first prism 381 or the second prism 382 such that the gap G1 is closed or opened.

The displayed virtual image 710 may also be closer than at infinity by using a substrate 7 which has slightly cylindrical surfaces, as disclosed e.g. in a patent application PCT/IB2004/004094. Thus, the displayed virtual image 710 may be at a distance of e.g. 1 to 2 meters from the eyes E1 of the viewer

The device 500 may be, for example, selected from the following list: a display module connectable to a further device, portable device, device with wireless telecommunicating capabilities, imaging device, mobile phone, gaming device, music recording/playing device (based on e.g. MP3-format), remote control transmitter or receiver, navigation instrument, measuring instrument, target finding device, aiming device, navigation device, personal digital assistant (PDA), communicator, portable internet appliance, hand-held computer, accessory to a mobile phone.

The diffractive beam expander 10a, 10b shown FIGS. 8 and 9 may be partially transparent such that the user PR1 may see his environment in addition to the virtual image displayed by the display device 500. Such device 500 has applications related to augmented reality.

The micro-display 22, the imaging optics 24, the diffractive beam expander 10, the optical engine 20, the display module 40, and/or the optical component 10, 12, 380, 381 for changing the operating mode of the device 500 may be delivered as separate custom-made components which may be optically, mechanically and/or electrically connectable to the other components of the device 500.

For the person skilled in the art, it will be clear that modifications and variations of the devices and the method according to the present invention are perceivable. The drawings are schematic. The particular embodiments described above with reference to the accompanying drawings are illustrative only and not meant to limit the scope of the invention, which is defined by the appended claims.

1. A device, comprising
a micro-display,
an imaging optics having an output aperture to transmit a light beam, and
a diffractive beam expander having an output grating,
wherein said micro-display and said imaging optics are adaptable to project said light beam in order to display a real image, and said diffractive beam expander is adaptable to intercept at least a part of said light beam such that a virtual image) is observable through a viewing aperture of said output grating.

2-24. (canceled)

25. The device according to claim 1, wherein an optical component of said device has a first state to couple at least a part of said light beam into said diffractive beam expander to enable a first mode of operation, said micro-display and said imaging optics being adapted to form a virtual image which is observable through a viewing aperture of said output grating in the first mode of operation, said component further having a second state to enable a second mode of operation, said micro-display and said imaging optics being adapted to project said light beam in order to display a real image in the second mode of operation.

26. The device according to claim 3, wherein an optical component of said device has a first position to set said diffractive beam expander at least partially into the path of said light beam in order to enable said first mode of operation, said optical component further having a second position to remove said diffractive beam expander at least partially from the path of said first light beam to enable said second mode of operation, the combination of said micro-display and said imaging optics being adapted to form a virtual image which is observable through a viewing aperture of said output grating in the first mode of operation, and the combination of said micro-display and said imaging optics being adapted to project said light beam in order to display a real image in the second mode of operation.

27. The device according to claim 1, comprising two separate diffractive beam expanders.

28. The device according to claim 1, further comprising a sliding mechanism to move said diffractive beam expander with respect to said output aperture.

29. The device according to claim 1, further comprising a hinge mechanism to move said diffractive beam expander with respect to said output aperture.

30. The device according to claim 1, wherein said output is a slanted surface relief grating to enhance efficiency of coupling light out of said diffractive beam expander.

31. The device according to claim 1, wherein said diffractive beam expander comprises a slanted surface relief grating to enhance coupling of light towards said output grating.

32. The device according to claim 1, comprising an optical connector to receive light from an external light source.

33. The device according to claim 1, further comprising an actuator to change the focusing of said light beam.

34. The device according to claim 4, further comprising a sensor to sense the position of said optical component.

35. The device according to claim 4, wherein the maximum luminous flux provided by said output aperture is adapted to be greater in said second mode of operation than in said first mode of operation.

36. The device according to claim 1, comprising two separate light paths for displaying stereoscopic virtual images.

37. A method comprising
displaying images by using a micro-display, an imaging optics having an output aperture, and a diffractive beam expander having an output grating,
forming a light beam by said micro-display and said imaging optics,
transmitting said light beam from said output aperture,
intercepting said light beam at least partially by said diffractive beam expander such that a virtual image is observable through a viewing aperture of said output grating, and
projecting said light beam in order to display a real image.

38. A method according to claim 15, comprising:
positioning an optical component to a first position with respect to said aperture to set said diffractive beam expander at least partially into the path of said light beam in order to enable a first mode of operation, and
positioning said optical component to a second position with respect to said aperture to remove said diffractive beam expander at least partially from the path of said first light beam to enable a second mode of operation,
wherein said micro-display and said imaging optics are together adapted to form a virtual image which is observable through the viewing aperture of said output grating in the first mode of operation, and said micro-display and said imaging optics being together adapted to project said light beam in order to display a real image in the second mode of operation.

39. The method according to claim 15, further comprising changing the focusing of said light beam.

40. A diffractive beam expander connectable to a combination of a micro-display and an imaging optics, said imaging optics having an output aperture to transmit a light beam, said diffractive beam expander having an output grating, wherein said micro-display and said imaging optics are adaptable to project said light beam in order to display a real image, and said diffractive beam expander is adaptable to transmit said light beam such that a virtual image is observable through a viewing aperture of said output grating.

41. The diffractive beam expander according to claim 18, further comprising a collimating element to collimate said light or a focusing element to focus said light beam.

42. The diffractive beam expander according to claim 18, further comprising a connecting mechanism to attach the diffractive beam expander to the front of said output aperture.
